(19) United States
(12) Patent Application Publication
(10) Pub. No.: US 2015/0049327 A1
(43) Pub. Date: Feb. 19, 2015

(54) Optical System

(71) Applicants: Sintai Optical (Shenzhen) Co., Ltd., Shenzhen City (CN); Asia Optical International Ltd., Tortola (GB)

(72) Inventors: Hua-Tang Liu, Taichung (TW); Ching-Shiang Wang, Taichung (TW); Wan-Yun Wu, Taichung (TW)

(21) Appl. No.: 14/458,294

(22) Filed: Aug. 13, 2014

(30) Foreign Application Priority Data
Aug. 16, 2013 (TW) 102129426

(51) Int. Cl. G01S 17/89; G01S 17/08

(52) U.S. Cl. CPC G01S 17/89; G01S 17/08
USPC 356/5.01

(57) ABSTRACT

An optical system includes a transmitter emitting a signal to a measured object; a receiver receiving the signal reflected back from the measured object; and a transmissive display device displaying a distance of the measured object measured by the range finder, wherein an image of the measured object is visible directly through the transmissive display device.

### BACKGROUND OF THE INVENTION

1. Field of the Invention

The invention relates to an optical system, and more particularly to an optical system adapted for a range finder.

2. Description of the Related Art

A typical range finder is able to emit a signal toward a measured object. The signal is reflected by the measured object and received by a receiver in the range finder. The range finder calculates the traveling time of the signal so as to obtain the distance of the measured object. Certain range finders such as a laser sight have an optical assembly to enlarge an image of a measured object to facilitate observation. Some range finders as cited in U.S. Pat. No. 7,614,156 further includes an image sensing device and a liquid crystal display device showing the enlarged image of an measured object for observation. The optical assembly, the image sensing device and the liquid crystal display device may occupy more space and increase weight, which is disadvantageous to transport and usage.

### BRIEF SUMMARY OF THE INVENTION

The invention provides an optical system. The optical system in accordance with an exemplary embodiment of the invention includes a transmitter emitting a signal to a measured object; a receiver receiving the signal reflected back from the measured object; and a transmissive display device displaying a distance of the measured object measured by the range finder, wherein an image of the measured object is visible directly through the transmissive display device.

In another exemplary embodiment, the optical system further includes a collective lens and a transmitting lens which are disposed between the transmitter and the measured object.

In yet another exemplary embodiment, the transmitter is a semiconductor laser or an infrared emitter.

In another exemplary embodiment, the optical system further includes a collective lens and a transmitting lens which are disposed between the receiver and the measured object.

In yet another exemplary embodiment, the receiver is an avalanche photodiode (APD) or a photo diode (PD).

In another exemplary embodiment, the transmissive display device is a liquid crystal display (LCD) or an organic light emitting diode (OLED).

The optical system in accordance with an exemplary embodiment of the invention essentially consists of a transmitter, a receiver, a plurality of collective lenses, a plurality of transmitting lenses, and a transmissive display device, wherein the transmitter emits a signal to a measured object; the receiver receives the signal reflected back by the measured object; the collective lenses are disposed between the transmitter and the measured object; the transmitting lenses are disposed between the transmitter and the measured object; the transmissive display device displays a distance of the measured object measured by the range finder; and an image of the measured object is visible directly through the transmissive display device.

In another exemplary embodiment, the transmitter is a semiconductor laser or an infrared emitter.

In yet another exemplary embodiment, the receiver is an avalanche photodiode (APD) or a photo diode (PD).

In another exemplary embodiment, the transmissive display device is a liquid crystal display (LCD) or an organic light emitting diode (OLED).

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an embodiment of an optical system of the invention; and

FIG. 2 shows the optical system of FIG. 1 measuring a distance of an object.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

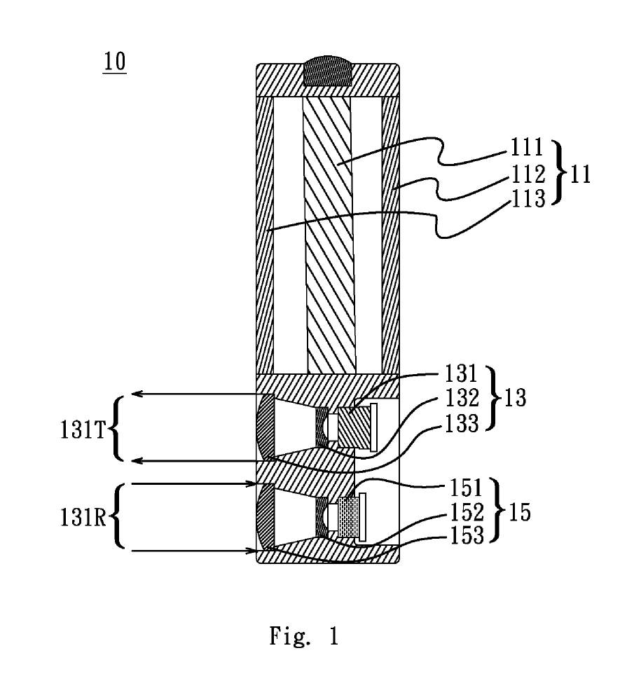

Referring to FIG. 1, an optical system 10 of the invention includes a display system 11, a transmitting system 13 and a receiving system 15. The display system 11 includes a transmissive display device 111, a first protective glass 112 and a second protective glass 113. The transmitting system 13 includes a transmitter 131, a collective lens 132 and a transmitting lens 133. The receiving system 15 includes a receiver 151, a collective lens 152 and a transmitting lens 153.

When the optical system 10 is used, the transmissive display device 111 faces a measured region (not shown), and an image of the measured region is visible directly through the transmissive display device 111. The optical system 11 is aimed at an measured object in the measured region, and the transmitting system 13 transmits light 131T to the measured object. The reflected light 131R is received and processed by the optical system 10 to obtain a distance of the measured object. The distance is displayed by the transmissive display device 111 for observation.

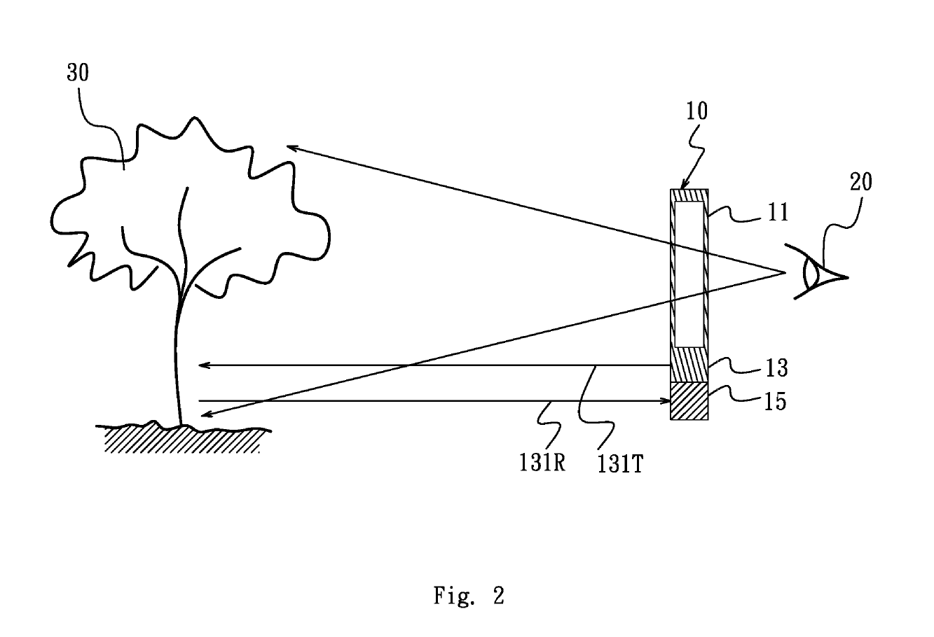

The optical path of the optical system 10 is described as follows. Referring to FIGS. 1 and 2, the optical system 10 is aimed at a measured region. The measured region is observed by a user's eyes 20 through the transmissive display device 111 directly. The optical system 10 is then regulated so that the transmissive display device 11 is aimed at a measured object 30 in the measured region. At this time, the measured object 30 is visible through the transmissive display device 111 directly.

The transmitter 131 transmits light 131T, which passes through the collective lens 132 and the transmitting lens 133 sequentially to reach the measured object 30, wherein the light 131T is collimated by the collective lens 132 and the transmitting lens 133. The reflected light beam 131R passes through the transmitting lens 153 and the collective lens 152 sequentially to reach the receiver 151. The light 131R is received and processed by the optical system 10 to obtain the distance of the measured object which is displayed by the transmissive display device 111.

In this embodiment, the transmitter 131 is a semiconductor laser, and the receiver 151 is an avalanche photodiode (APD) or a photo diode (PD). The transmissive display device 111 is a liquid crystal display (LCD) or an organic light emitting diode (OLED).

In another embodiment, the transmitter 131 is an infrared emitter, and the receiver 151 is an infrared receiver.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An optical system for a range finder, comprising:
a transmitter emitting a signal to a measured object;
a receiver receiving the signal reflected back from the measured object; and
a transmissive display device displaying a distance of the measured object measured by the range finder, wherein an image of the measured object is visible directly through the transmissive display device.

2. The optical system as claimed in claim 1 further comprising a collective lens and a transmitting lens which are disposed between the transmitter and the measured object.

3. The optical system as claimed in claim 1, wherein the transmitter is a semiconductor laser or an infrared emitter.

4. The optical system as claimed in claim 1 further comprising a collective lens and a transmitting lens which are disposed between the receiver and the measured object.

5. The optical system as claimed in claim 1, wherein the receiver is an avalanche photodiode (APD) or a photo diode (PD).

6. The optical system as claimed in claim 1, wherein the transmissive display device is a liquid crystal display (LCD) or an organic light emitting diode (OLED).

7. An optical system for a range finder, essentially consisting of a transmitter, a receiver, a plurality of collective lenses, a plurality of transmitting lenses, and a transmissive display device, wherein the transmitter emits a signal to a measured object; the receiver receives the signal reflected back by the measured object; the collective lenses are disposed between the transmitter and the measured object; the transmitting lenses are disposed between the transmitter and the measured object; the transmissive display device displays a distance of the measured object measured by the range finder; and an image of the measured object is visible directly through the transmissive display device.

8. The optical system as claimed in claim 7, wherein the transmitter is a semiconductor laser or an infrared emitter.

9. The optical system as claimed in claim 7, wherein the receiver is an avalanche photodiode (APD) or a photo diode (PD).

10. The optical system as claimed in claim 7, wherein the transmissive display device is a liquid crystal display (LCD) or an organic light emitting diode (OLED).
